(19) United States
(12) Patent Application Publication
(10) Pub. No.: US 2025/0329782 A1
(43) Pub. Date: Oct. 23, 2025

(54) ELECTROLYTE FOR LITHIUM SULFUR BATTERY AND LITHIUM SULFUR BATTERY

(71) Applicant: ABRI Co., Ltd., Hachioji-shi, Tokyo (JP)

(72) Inventors: Koshin TAKEMOTO, Tokyo (JP); Jungo WAKASUGI, Tokyo (JP); Masaaki KUBOTA, Tokyo (JP); Hidetoshi ABE, Tokyo (JP)

(73) Assignee: ABRI Co., Ltd., Hachioji-shi, Tokyo (JP)

(21) Appl. No.: 18/868,429

(22) PCT Filed: Jan. 16, 2024
(86) PCT No.: PCT/JP2024/001021

§ 371 Date: Nov. 22, 2024

(30) Foreign Application Priority Data
Jan. 16, 2023 (JP) 2023-004534

(51) Int. Cl. H01M 10/0567; H01M 10/0525; H01M 10/0568; H01M 10/0569

(52) U.S. Cl. CPC H01M 10/0567; H01M 10/0525; H01M 10/0568; H01M 10/0569

(57) ABSTRACT

An electrolyte, the electrolyte including: a first component; a second component; and a solvent, where the first component includes lithium polysulfide, the second component includes lithium bis(fluorosulfonyl)imide, and a concentration A of the lithium bis(fluorosulfonyl)imide satisfies 0.001 mol/dm³≤A≤0.15 mol/dm³.

### FIELD

The present invention relates to an electrolyte for a lithium sulfur battery and the lithium sulfur battery.

### BACKGROUND

Lithium ion secondary batteries have been conventionally widely used in equipment, such as small electronic devices, electric vehicles, and smart grids. On the other hand, the proliferation of electric vehicles and the promotion of the use of renewable energy require a battery having a still higher energy density. However, the energy density of lithium ion secondary batteries has reached the upper limit, and hence new materials or new battery systems need to be developed. Among them, lithium sulfur batteries have been attracting attention as one of next-generation batteries because the achievement of high energy density can be expected. A typical lithium sulfur battery includes: a positive electrode including sulfur, a negative electrode including lithium metal, and a separator including an organic liquid-based electrolyte.

For the commercialization of lithium sulfur batteries, it is necessary to improve cycle performance of the lithium sulfur batteries. One of causes for a decrease in cycle performance is that lithium polysulfide serving as an intermediate active material dissolves in an electrolyte. Lithium polysulfide is produced on the positive electrode side during charge and discharge and dissolves in an electrolyte. In a lithium sulfur battery, the above-mentioned dissolution causes a decrease in the capacity of a positive electrode. As a method for substantially suppressing the dissolution of lithium polysulfide, there is known a method in which lithium polysulfide is added to an electrolyte as described in Non Patent Literature 1, for example. In this method, the electrolyte is allowed to contain lithium polysulfide beforehand, whereby the dissolution of lithium polysulfide dissolving gradually from a positive electrode is substantially suppressed (delayed) to prevent a decrease in the capacity of the positive electrode.

However, in the method described in Non-Patent Literature 1, polysulfide ions are excessively reduced and decomposed on a lithium negative electrode during charging, which promotes the precipitation of needle-like crystals (dendrite) of lithium metal. It has been deemed that, at this time, an unstable decomposition product film is formed on the lithium metal, thereby promoting the precipitation of dendrite. The precipitation of dendrite causes a shorter service life of a lithium metal negative electrode and a decrease in coulombic efficiency, and furthermore causes a short circuit.

Here, it is well known that lithium bis(fluorosulfonyl)imide is a suitable material to form a stable decomposition product film and solve the problem of a lithium metal negative electrode (for example, see Non Patent Literatures 2 and 3). On the other hand, it is well known that, in lithium sulfur batteries, an electrolyte including lithium bis(fluorosulfonyl)imide is an unsuitable material for a sulfur positive electrode because such electrolyte promotes a decrease in the capacity of the sulfur positive electrode (for example, see Non Patent Literature 4).

### CITATION LIST

### Non Patent Literature

Non Patent Literature 1: M. Agostini et al., Chem. Mater. 2015, 27, 4604
Non Patent Literature 2: J. Qian et al., Nat. Commu. 2015, 6, 6362
Non Patent Literature 3: Y. Maeyoshi et al., ACS Appl. Mater. Interfaces. 2019, 11 (29), 25833
Non Patent Literature 4: R. Cao et al., Adv. Funct. Mater. 2016, 26, 3059

### SUMMARY

### Technical Problem

As described above, lithium polysulfide is a material that can be expected to enhance the performance of a sulfur positive electrode and lithium bis(fluorosulfonyl)imide is a material that can be expected to enhance the performance of a negative electrode including a lithium alloy or lithium metal. On the contrary, lithium polysulfide is a material that promotes the performance degradation of the negative electrode including the lithium alloy or the lithium metal and lithium bis(fluorosulfonyl)imide is a material that promotes the performance degradation of the sulfur positive electrode, hence the use of lithium polysulfide and lithium bis(fluorosulfonyl)imide as materials of a lithium sulfur battery is problem in terms of enhancing cycle performance.

The present invention was made in view of the above, and an object of the present invention is to provide an electrolyte and a lithium sulfur battery that has high cycle performance.

### Solution to Problem

When the effects of an electrolyte including either lithium polysulfide or lithium bis(fluorosulfonyl)imide on battery performance were examined, satisfactory performance was not achieved. Then, when the inventors added lithium polysulfide and lithium bis(fluorosulfonyl)imide at the same time and examined the concentrations thereof, the inventors found the achievement of very high performance, and thus completed the present invention.

In order to solve the problem above and achieve the object, as a first aspect, an electrolyte for a lithium sulfur battery according to the present invention includes: a first component; a second component; and a solvent. The first component is lithium polysulfide, and the second component is lithium bis(fluorosulfonyl)imide, and a concentration A of the lithium bis(fluorosulfonyl)imide satisfies 0.001 mol/dm³≤A≤0.15 mol/dm³.

In the electrolyte for the lithium sulfur battery according to the present invention, in addition to the first aspect, as a second aspect, a concentration B of the lithium polysulfide satisfies 0.2 mol/dm³≤B≤2.0 mol/dm³.

In the electrolyte for the lithium sulfur battery according to the present invention, in addition to the first aspect and/or the second aspect, as a third aspect, the concentration A satisfies 0.05 mol/dm³≤A≤0.15 mol/dm³.

In the electrolyte for the lithium sulfur battery according to the present invention, in addition to any one of the first aspect to the third aspect, as a fourth aspect, the concentration B satisfies 0.2 mol/dm³≤B≤0.6 mol/dm³.

In the electrolyte for the lithium sulfur battery according to the present invention, in addition to any one of the first aspect to the fourth aspect, as a fifth aspect, besides the first component and the second component, the electrolyte further includes at least one lithium salt as a third component, and a concentration of the lithium salt is higher than 0 mol/dm³ and 1.5 mol/dm³ or lower.

In the electrolyte for the lithium sulfur battery according to the present invention, in addition to any one of the first aspect to the fifth aspect, as a sixth aspect, the lithium salt includes at least one of lithium bis(trifluoromethanesulfonyl)imide, lithium nitrate, and lithium trifluoromethanesulfonate.

In the electrolyte for the lithium sulfur battery according to the present invention, in addition to any one of the first aspect to the sixth aspect, as a seventh aspect, the solvent is 1,3-dioxolane and 1,2-dimethoxyethane.

As an eighth aspect, a lithium sulfur battery according to the present invention includes: a negative electrode including lithium metal or a lithium alloy; a positive electrode including sulfur or a sulfur compound as a major component of a positive electrode active material; and the electrolyte for the lithium sulfur battery according to any one of the first aspect to the seventh aspect.

In the lithium sulfur battery according to the present invention, in addition to the eighth aspect, as a ninth aspect, the positive electrode includes sulfur modified polyacrylonitrile and lithium titanate.

In the lithium sulfur battery according to the present invention, in addition to any one of the eighth aspect and the ninth aspect, as a tenth aspect, the positive electrode further includes a conductive additive.

In the lithium sulfur battery according to the present invention, in addition to any one of the eighth aspect to the tenth aspect, as an eleventh aspect, the positive electrode further includes porous carbon.

### Advantageous Effects of Invention

According to the present invention, an electrolyte and a lithium sulfur battery that has high cycle performance can be achieved.

### BRIEF DESCRIPTION OF DRAWINGS

FIG. 1 is a cross-sectional view illustrating the configuration of a lithium sulfur battery including an electrolyte for the lithium sulfur battery according to one embodiment of the present invention.

FIG. 2 is a scanning electron microscope image of a surface of the lithium sulfur battery before charging and discharging.

FIG. 3 is a scanning electron microscope image of a surface of a lithium sulfur battery in Example 4.

FIG. 4 is a scanning electron microscope image of a surface of a lithium sulfur battery in Comparative Example 1.

### DESCRIPTION OF EMBODIMENTS

Hereinafter, an embodiment of the present invention will be described, but, the present invention is not limited by the following description. Various modifications or improvements can be given to the present embodiment, and an embodiment resulting from such modifications or improvements can also be included in the present invention.

### EMBODIMENT

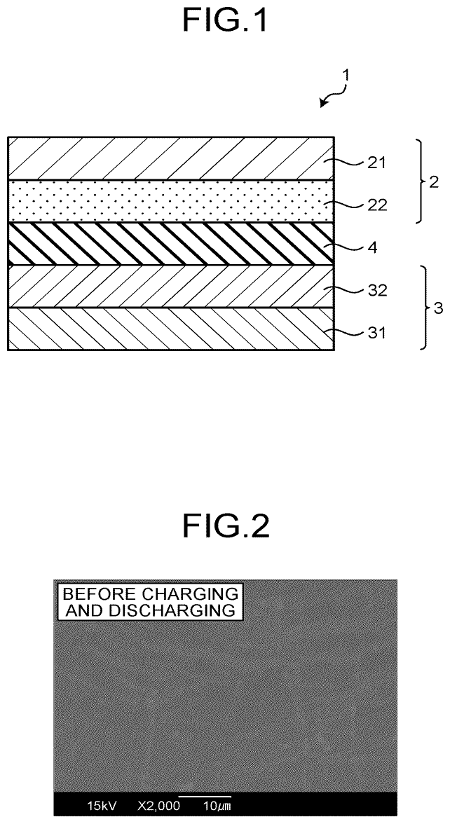

FIG. 1 is a cross-sectional view illustrating the configuration of a lithium sulfur battery including an electrolyte for the lithium sulfur battery according to one embodiment of the present invention. A lithium sulfur battery 1 includes a positive electrode 2, a negative electrode 3, and a separator 4 disposed between the positive electrode 2 and the negative electrode 3. The positive electrode 2, the negative electrode 3, and the separator 4 are accommodated in an outer casing (not illustrated). The lithium sulfur battery 1 is formed by the permeation of the electrolyte through the positive electrode 2, the negative electrode 3, and the separator 4. Note that the shape of the lithium sulfur battery 1 is not limited to a shape illustrated in FIG. 1, and may be, for example, a coin, button, sheet, stacked, cylindrical, rectangular, or flat shape.

### [Positive Electrode]

A positive electrode includes a positive electrode current collector and a positive electrode composite layer. Specifically, the positive electrode 2 includes: a positive electrode current collector 21; and a positive electrode composite layer 22 disposed on a surface of the positive electrode current collector 21, the surface facing the separator 4.

### <Positive Electrode Current Collector>

The positive electrode current collector 21 is not limited to a particularly one, but a well-known or commercially available material can be used as the positive electrode current collector 21. Examples of the positive electrode current collector 21 includes aluminum and an aluminum alloy. Examples of a material of the positive electrode current collector 21 include aluminum foil, carbon-coated aluminum foil, aluminum or other metal mesh, porous metal, expanded metal, and perforated metal.

### <Positive Electrode Composite Layer>

The positive electrode composite layer 22 includes sulfur and/or a sulfur compound.

(Sulfur and/or Sulfur Compound)

Here, to achieve high energy density, the content of sulfur and/or the sulfur compound is preferably 50% by weight or higher, more preferably within a range of 55% to 90% by weight, and still more preferably within a range of 55% to 65% by weight with respect to the weight of the positive electrode composite layer 22. When the content of sulfur and/or the sulfur compound is less than 50% by weight, the amount of a positive electrode active material contained in the positive electrode composite layer decreases, which incurs the risk of a decrease in the energy density of the lithium sulfur battery, and this is undesirable. From the viewpoint of achieving excellent rate performance and cycle performance and reducing polarization, an electrically conductive additive is preferably used in the positive electrode composite layer 22. Furthermore, in the case of including an electrically conductive additive, what is prepared by combining sulfur and/or the sulfur compound with the electrically conductive additive beforehand is more preferably used. Hereinafter, what is prepared by combining sulfur and/or the sulfur compound with the electrically conductive additive is referred to as a composite. A method of combining is not limited to a particular one, and any well-known method may be applied, and examples thereof include melt impregnation, electrolytic deposition, vapor deposition, immersion, and mechanical milling. Melt impregnation is more preferably used, and electrolytic deposition is still more preferably used. In addition, to enhance binding strength, the positive electrode composite layer 22 may include a binder (a binding agent). In addition, to achieve excellent rate performance and cycle performance and reduce polarization, an additive (a positive electrode additive) is preferably used for the positive electrode composite layer 22.

As the sulfur and the sulfur compound, a well-known type of sulfur and a well-known sulfur compound can be used. Specific examples of the sulfur and the sulfur compound include crystalline sulfur, granular sulfur, colloidal sulfur, lithium sulfide, and sulfurized polyacrylonitrile. The positive electrode composite layer 22 may include only one type of sulfur or two or more types of sulfur. When two or more types of sulfur are included, any combination and ratio thereof can be selected according to the purpose. Furthermore, sulfur and the sulfur compound may be used in the form of a composite or in the form of single components, or used in the form of a mixture thereof. In particular, in addition to the composite, sulfurized polyacrylonitrile is preferably added separately. For example, the reason why sulfurized polyacrylonitrile is added is that discharge capacity and cycle performance are enhanced.

### (Electrically Conductive Additive)

As the electrically conductive additive, any well-known electrically conductive additive can be used. Specific examples of the electrically conductive additive include Ketjen black, carbon nanotubes, graphene, graphene oxide, reduced graphene oxide, acetylene black, and porous carbon. In particular, porous carbon is preferably used because of its ability to develop a high capacity. To achieve excellent rate performance and cycle performance and reduce polarization, the electrically conductive additive preferably has a specific surface area of 500 to 2500 m²/g. Only one type or two or more types of the electrically conductive additive may be included. When two or more types of electrically conductive additive are included, any combination and ratio thereof can be selected according to the purpose. The electrically conductive additive may be used in the form of a composite or in the form of single components, or used in the form of a mixture thereof. In particular, in addition to a composite, a single component is preferably added separately. For example, the reason why a simple substance is added is that such addition enhances outputperformance.

### (Binder)

As the binder, a well-known binder can be used. Specific examples of the binder include polyvinylidene fluoride (PVDF), polyvinylidene fluoride-hexafluoropropylene copolymers (PVDF-HFP), polyacrylic acid (PAA), lithium polyacrylate (PAALi), styrene butadiene rubber (SBR), polyvinyl alcohol (PVA), polyethylene oxide (PEO), polyethylene glycol (PEG), carboxymethyl cellulose (CMC), polyacrylonitrile (PAN), and polyimide (PI). Only one type or two or more types of binders may be included. When two or more types of binders are included, any combination and ratio thereof can be selected according to the purpose.

### (Positive Electrode Additive)

Specific examples of the positive electrode additive include: lithium ion-conducting oxides, such as LiCoO₂, LiMn₂O₄, LiNiO₂, LiNiCoMnO₂, LiNi_{0.5}Mn_{0.5}O₂, LiMPO₄(M=a transition metal such as Ma, Fe, Co, or Ni), LiNi_{0.8}Co_{0.15}Al_{0.05}O₂, Li_{1+x+y}Alₓ(Ti,Ge)₂₋ₓSi_{y}P_{3-y}O₁₂, lithium titanate (for example, Li₄Ti₅O₁₂, LiTiO₄, Li₂Ti₃O₇), Li_{0.35}La_{0.55}TiO₃, and Li₇La₃Zr₂O₁₂; and nitrogen-containing organic compounds, such as cyclic polyacrylonitrile and derivatives thereof, poly(N-vinylcarbazole) and derivatives thereof, poly(benzoimidazobenzophenanthroline) and derivatives thereof, poly(N-vinylpyridine) and derivatives thereof, poly(N-vinylpyrrolidone) and derivatives thereof, and tetraphenylporphyrin and derivatives thereof. Only one type or two or more types of positive electrode additives may be included. When two or more types of positive electrode additives are included, any combination and ratio thereof can be selected according to the purpose. In particular, lithium titanate is preferably used. The reason why lithium titanate is used is that lithium titanate has high ionic conductivity and high electronic conductivity. Note that the positive electrode additive sometimes acts as an active material.

The positive electrode composite layer 22 can be formed, for example, by dispersing a material in a solvent to obtain a slurry, applying the slurry to the positive electrode current collector 21, and then drying the slurry to remove the solvent. The positive electrode composite layer 22 may be formed on only one side of the positive electrode current collector 21 or formed on both sides thereof.

Examples of the solvent for the slurry include N-methyl-2-pyrrolidone (NMP) and water.

### [Negative Electrode]

As the negative electrode 3, a negative electrode including a negative electrode active material capable of absorbing and releasing lithium is used. For example, the negative electrode 3 includes: a negative electrode current collector 31; and a negative electrode composite layer 32 including a negative electrode active material and disposed on a surface of the negative electrode current collector 31, the surface facing the separator 4. The negative electrode composite layer 32 may be formed on only one side of the negative electrode current collector 31 or formed on both sides thereof.

The negative electrode current collector 31 can be selected from the group consisting of copper, aluminum, stainless steel, titanium, silver, palladium, nickel, and alloys thereof, and combinations thereof. Stainless steel may be surface-treated with carbon, nickel, titanium or silver. Examples of the alloys include an aluminum-cadmium alloy. Other materials such as baked carbon, non-conductive polymers that are surface-treated with an electrically conductive material, and conductive polymers can be used as the negative electrode current collector 31.

Examples of the negative electrode active material in the negative electrode composite layer 32 include metal materials such as lithium metal and lithium-containing alloys such as a lithium-aluminum alloy, a lithium-tin alloy, a lithium-lead alloy, and a lithium-silicon alloy. One or two or more metal materials can be used as the negative electrode active material. In the case of using two or more metal materials, any combination and ratio thereof can be selected according to the purpose.

Note that the negative electrode 3 can be configured without the negative electrode current collector 31.

### [Electrolyte]

The electrolyte includes a solvent, lithium polysulfide as a first component, and lithium bis(fluorosulfonyl)imide as a second component.

From the viewpoint of achieving high cycle performance, the concentration A of lithium bis(fluorosulfonyl)imide in the electrolyte preferably satisfies 0.001 mol/dm³≤A≤0.15 mol/dm³ and more preferably satisfies 0.05 mol/dm³≤A≤0.15 mol/dm³. Although a detailed reason for the above is unknown, when the concentration of lithium bis(fluorosulfonyl)imide is within the above-mentioned range, the formation of dendrites in the lithium metal negative electrode can be substantially suppressed, whereby the effect of substantially suppressing shortening the service life and a decrease in the coulombic efficiency can be achieved. In contrast, in the case of satisfying A<0.001 mol/dm³, the coulombic efficiency decreases (irreversible capacity increases). In the case of satisfying 0.15 mol/dm³<A, the ability of capacity retention decreases (positive electrode degradation is accelerated).

In the present specification, the concentration (mol/dm³) of each component means a desired number of moles of the component with respect to 1 dm³ of the organic solvent.

The concentration B of lithium polysulfide preferably satisfies 0.001 mol/dm³≤B≤2.0 mol/dm³, more preferably satisfies 0.2 mol/dm³≤B≤2.0 mol/dm³, and particularly preferably satisfies 0.2 mol/dm³≤B≤0.6 mol/dm³. When the concentration B of lithium polysulfide is higher than 2.0 mol/dm³, the viscosity of the electrolyte increases (the ion conductivity decreases), which incurs the risk of a decrease in capacity. Here, the concentration of lithium polysulfide is the total concentration of a lithium polysulfide contained beforehand in the electrolyte and a lithium polysulfide dissolving from the electrode. Lithium polysulfide mentioned here includes Li₂S₈, Li₂S₆, Li₂S₄, and Li₂S₂. Since the electrolyte includes lithium polysulfide, lithium polysulfide can be substantially suppressed from dissolving from the electrode. Theoretically, the behavior for the prevention of dissolving is deemed to obey the Noyes-Whitney equation and the law of chemical equilibrium.

Lithium polysulfide included in the electrolyte, other than lithium polysulfide dissolving from the electrode, is preferably added before the assembly of a lithium sulfur battery. When lithium polysulfide is added before the assembly, lithium polysulfide can function as an active material and thereby achieve high discharge capacity, and furthermore, in accordance with the Noyes-Whitney equation and the law of chemical equilibrium, lithium polysulfide can be substantially suppressed from dissolving from the electrode, whereby a decrease in capacity can be substantially suppressed. In the present invention, degradation of lithium metal negative electrode caused by the addition of lithium polysulfide prior to the assembly can be substantially suppressed by the addition of lithium bis(fluorosulfonyl)imide. The concentration A of lithium bis(fluorosulfonyl)imide to be used is within a range of 0.001 mol/dm³≤A≤0.15 mol/dm³. When the concentration A exceeds 0.15 mol/dm³, the degradation of the positive electrode occurs and cycle performance decrease.

To prepare lithium polysulfide, sulfur and lithium sulfide are preferably mixed at a molar ratio of 7:1 to 3:1 and synthesized. However, there is no problem in making use of lithium polysulfide resulting from synthesis using other methods.

Furthermore, from the viewpoint of enhancing ionic conductivity, besides lithium polysulfide and lithium bis(fluorosulfonyl)imide, a lithium salt is preferably included as a third component. Examples of the lithium salt include lithium hexafluorophosphate (LiPF₆), lithium perchlorate (LiClO₄), lithium bisoxalate borate (LiB(C₂O₄)), lithium borohydride (LiBF₄), lithium nitrate (LiNO₃), lithium bis(trifluoromethanesulfonyl)imide (LiTFSI), and lithium trifluoromethanesulfonate (LiTFS). At least one of lithium nitrate, lithium bis(trifluoromethanesulfonyl)imide, and lithium trifluoromethanesulfonate is preferably included. The reason why the above-mentioned lithium salts are included that cycle performance can be enhanced. Only one or two or more lithium salts may be used. When two or more lithium salts are included, any combination and ratio thereof can be selected according to the purpose. From the viewpoint of achieving high capacity, the total of the concentrations of the lithium salts other than lithium polysulfide and lithium bis(fluorosulfonyl)imide is preferably higher than 0 mol/dm³ and 1.5 mol/dm³ or lower, and more preferably 0.1 mol/dm³ or higher and 1.0 mol/dm³ or lower.

Examples of the solvent include ethylene carbonate, ethyl methyl carbonate, propylene carbonate, dimethyl carbonate, diethyl carbonate, 1,3-dioxolane, 1,2-dimethoxyethane, sulfolane, oxolane, and ionic liquids. Preferably, 1,3-dioxolane and 1,2-dimethoxyethane are included. Only one or two or more solvents may be included. When two or more solvents are included, any combination and ratio thereof can be selected according to the purpose.

As described later, the concentration of each of the first, second, and third components in the electrolyte is not a value calculated from the amount of the electrolyte preparation, but a value measured from the electrolyte taken out of a fully-charged lithium sulfur battery that has completed initial activation. For example, the concentrations are determined by ion chromatography. More specifically, using ion chromatography, the type of anions in the electrolyte is identified and the measured intensity of the anions is determined. From the measured intensity and a calibration curve produced beforehand, the concentration of anions in the electrolyte is determined. Even in the case of a lithium sulfur battery on the market without undergoing initial activation, when the lithium sulfur battery subsequently undergoes initial activation, the lithium sulfur battery can be regarded as a lithium sulfur battery that has completed initial activation. Whether or not a lithium sulfur battery has completed initial activation is determined by the surface shape of the negative electrode at a point in time when the lithium sulfur battery is disassembled. When the surface of the lithium metal negative electrode is flat, it is considered that the lithium sulfur battery has not completed initial activation.

Here, conditions for initial activation are not limited to particular ones, but, for example, discharging is performed at an ambient temperature of 0° C. to 60° C. and a current density of 0.01 to 1.0 mA/cm² until 1.0 to 1.7 V is attained, and then charging is performed at the same current value until 2.4 to 3.0 V is attained, and several cycles of the discharging and the charging are repeated.

### [Separator]

The separator 4 may be either an organic polymer separator or an inorganic separator and is made of a material that does not react with the positive electrode 2, the negative electrode 3, and the electrolyte.

Examples of a polymer constituting the organic polymer separator include polypropylene, polyolefin, nitrocellulose, and polyimide. Examples of the polymer separator include a polymer separator having undergone treatment such as ceramic coating or structure control. Here, only one or two or more types of treatment may be applied. When two or more types of treatment are applied, any treatment condition, such as a combination thereof, can be selected according to the purpose.

Examples of the inorganic separator include silica glass non-woven fabrics. Furthermore, examples of the inorganic separator include an inorganic separator having undergone treatment such as ceramic coating or structure control. Here, only one or two or more types of treatment may be applied. When two or more types of treatment are applied, any treatment condition, such as a combination thereof, can be selected according to the purpose.

In the present embodiment described above, in the lithium sulfur battery including: the negative electrode including lithium metal or the lithium metal alloy; the positive electrode including sulfur or the sulfur compound as a main component of the positive electrode active material; and the electrolyte including lithium polysulfide as the first component, lithium bis(fluorosulfonyl)imide as the second component, and the organic solvent, the concentration A of lithium bis(fluorosulfonyl)imide is configured to satisfy 0.001 mol/dm³≤A≤0.15 mol/dm³. According to the present embodiment, satisfying the above-mentioned conditions allows a lithium sulfur battery having high cycle performance to be achieved.

### EXAMPLES

Hereinafter, examples will be illustrated to describe the present invention in more detail, but the present invention is not limited by the following examples.

In Examples, lithium polysulfide and lithium bis(fluorosulfonyl)imide were added to an electrolyte, and concentrations thereof and other compositions were changed. In Comparative Examples, an electrolyte to which either lithium polysulfide or lithium bis(fluorosulfonyl)imide was added as well as an electrolyte in which the amount of lithium bis(fluorosulfonyl)imide added was out of the range disclosed in claim 1 were produced.

### [Production of Lithium Sulfur Battery]

Sulfur(S) and porous carbon (Cnovel (registered trademark), manufactured by TOYO TANSO CO., LTD.) were mixed at a weight ratio of 70:30, and heat treatment is applied to the resulting mixture in an inert gas atmosphere at 155° C. for 12 hours to permeate S into pores of the porous carbon. Hereinafter, the resulting product is referred to as a S/porous-carbon composite. The S/porous-carbon composite, acetylene black (AB), carbon nanotubes (CNT), a binder, ultrapure water, sulfurized polyacrylonitrile (SPAN: manufactured by ADEKA CORPORATION), and lithium titanate (Li₄Ti₅O₁₂, manufactured by FUJIFILM Wako Pure Chemical Corporation (maker: Toshima Manufacturing Co., Ltd.)) were uniformly kneaded and stirred using a defoaming stirrer “Awatori Rentaro” (manufactured by THINKY CORPORATION). The obtained slurry of the positive electrode composite was applied onto carbon-coated aluminum foil so that the amount of sulfur supported was 4.4 mg/cm² and vacuum-dried overnight at 60° C. The composition of the positive electrode composite was such that S/porous-carbon composite: AB:CNT: binder:lithium titanate:sulfurized polyacrylonitrile=85:1:2:5:6:1 (percent by weight). Lithium metal was used as the negative electrode. Any negative electrode current collector was not used. A PP separator manufactured by Celgard was used as a separator. A lithium sulfur battery was produced and used as an example, in which a separator was disposed between the positive electrode and the negative electrode, the separator including an electrolyte, the electrolyte made from a mixture of:lithium bis(trifluoromethanesulfonyl)imide (hereinafter, referred to as LiTFSI) as a lithium salt; 1,3-dioxolane (DOL), 1,2-dimethoxyethane (DME), or lithium bis(fluorosulfonyl)imide (LiFSI) as a solvent, and lithium polysulfide. The production of the lithium sulfur battery was performed under an inert gas atmosphere. Note that, in the case of preparing lithium polysulfide for the electrolyte beforehand, lithium polysulfide was synthesized and prepared by mixing sulfur and lithium sulfide at a molar ratio of 7:1. Furthermore, DOL:DME is 1:1 in volume ratio.

### Example 1

In Example 1, a lithium sulfur battery was produced, in which the concentration of LiTFSI in the electrolyte was 1 mol/dm³, the concentration of Li₂S₈ used as lithium polysulfide in the electrolyte was 0.2 mol/dm³, and the concentration of LiFSI in the electrolyte was 0.01 mol/dm³. A composition and physical properties according to Example 1 are illustrated in Table 1.

TABLE 1

| | | Type of | | | | | | Capacity | |
|---|---|---|---|---|---|---|---|---|---|
| | | lithium | | Lithium | w/ or | w/ or | | retention | Average |
| | | polysulfide | Lithium | bis(fluoro- | w/o | w/o | Discharge | rate @ | coulombic |
| | | added to | polysulfide | sulfonyl)imide | LTO/ | porous | capacity | 30th cycle | efficiency |
| | Lithium salt/Solvent | electrolyte | (mol/dm³) | (mol/dm³) | SPAN | carbon | (mAh/g) | (%) | (%) |
| Example 1 | 1.0 mol/dm³ LiTFSI/DOL:DME | Li₂S [symbol] | 0.2 | 0.01 | w/ | w/ | 1352 | 62 | 75 |
| Example 2 | 1.0 mol/dm³ LiTFSI/DOL:DME | Li₂S [symbol] | 0.2 | 0.05 | w/ | w/ | 1336 | 68 | 78 |
| Example 3 | 1.0 mol/dm³ LiTFSI/DOL:DME | Li₂S [symbol] | 0.2 | 0.1 | w/ | w/ | 1388 | 67 | 80 |
| Example 4 | 1.0 mol/dm³ LiTFSI/DOL:DME | Li₂S [symbol] | 0.2 | 0.15 | w/ | w/ | 1302 | 69 | 81 |
| Example 5 | DOL:DME | Li₂S [symbol] | 0.2 | 0.15 | w/ | w/ | 1240 | 60 | 70 |
| Example 6 | 1.0 mol/dm³ LiTFSI/DOL:DME | Li₂S [symbol] | 0.2 | 0.15 | w/ | w/ | 1389 | 67 | 70 |
| Example 7 | 0.5 mol/dm³ LiTFSI/DOL:DME | Li₂S [symbol] | 0.2 | 0.15 | w/ | w/ | 1502 | 67 | 75 |
| Example 8 | 1.5 mol/dm³ LiTFSI/DOL:DME | Li₂S [symbol] | 0.2 | 0.15 | w/ | w/ | 1398 | 70 | 81 |
| Example 9 | 2.0 mol/dm³ LiTFSI/DOL:DME | Li₂S [symbol] | 0.2 | 0.15 | w/ | w/ | 908 | 81 | 83 |
| Example 10 | 0.5 mol/dm³ LiTFSI/DOL:DME | Li₂S [symbol] | 0.4 | 0.15 | w/ | w/ | 1488 | 71 | 79 |
| Example 11 | 0.5 mol/dm³ LiTFSI/DOL:DME | Li₂S [symbol] | 0.6 | 0.15 | w/ | w/ | 1458 | 69 | 80 |
| Example 12 | 0.5 mol/dm³ LiTFSI/DOL:DME | Li₂S [symbol] | 1.0 | 0.15 | w/ | w/ | 1203 | 70 | 75 |
| Example 13 | 0.5 mol/dm³ LiTFSI/DOL:DME | Li₂S [symbol] | 2.0 | 0.15 | w/ | w/ | 1068 | 77 | 69 |
| Example 14 | 0.5 mol/dm³ LiNO₃/DOL:DME | Li₂S [symbol] | 0.2 | 0.15 | w/ | w/ | 1499 | 69 | 80 |
| Example 15 | 0.5 mol/dm³ LiTFS/DOL:DME | Li₂S [symbol] | 0.2 | 0.15 | w/ | w/ | 1504 | 68 | 79 |
| Example 16 | 0.5 mol/dm³ LiTFSI/DOL:DME | Li₂S [symbol] | 0.2 | 0.15 | w/ | w/ | 1449 | 71 | 74 |
| Example 17 | 0.5 mol/dm³ LiTFSI/DOL:DME | Li₂S₄ | 0.2 | 0.15 | w/ | w/ | 1401 | 68 | 79 |
| Example 18 | 0.5 mol/dm³ LiTFSI/DOL:DME | Li₂S₂ | 0.2 | 0.15 | w/ | w/ | 1322 | 67 | 78 |
| Example 19 | 1.0 mol/dm³ LiTFSI/DOL:DME | Li₂S [symbol] | 0.2 | 0.15 | w/o | w/ | 1135 | 71 | 80 |
| Example 20 | 1.0 mol/dm³ LiTFSI/DOL:DME | Li₂S [symbol] | 0.2 | 0.15 | w/ | w/o | 974 | 81 | 82 |
| Example 21 | 0.5 mol/dm³ LiClO₄/DOL:DME | Li₂S [symbol] | 0.2 | 0.15 | w/ | w/ | 1401 | [symbol] | 72 |
| Example 22 | 0.5 mol/dm³ LiPF [symbol] /DOL:DME | Li₂S [symbol] | 0.2 | 0.15 | w/ | w/ | 1421 | 51 | 71 |
| Example 23 | 0.5 mol/dm³ LiTFSI/SL | Li₂S [symbol] | 0.2 | 0.15 | w/ | w/ | 904 | [symbol] | 83 |
| Example 24 | 0.5 mol/dm³ LiTFSI/G4 | Li₂S [symbol] | 0.2 | 0.15 | w/ | w/ | 1102 | [symbol] | 86 |
| Comparative | 1.0 mol/dm³ LiTFSI/DOL:DME | Li₂S [symbol] | 0.3 | — | w/ | w/ | short-circuited at the 15th circle | | |
| Example 1 | | | | | | | | | |
| Comparative | 1.0 mol/dm³ LiTFSI/DOL:DME | Li₂S [symbol] | 0.3 | — | w/ | w/ | short-circuited at the 17th circle | | |
| Example 2 | | | | | | | | | |
| Comparative | 1.0 mol/dm³ LiTFSI/DOL:DME | Li₂S [symbol] | 0.2 | 0.2 | w/ | w/ | 1284 | 47 | 87 |
| Example 3 | | | | | | | | | |

[symbol]

indicates data missing or illegible when filed

### Example 2

In Example 2, a lithium sulfur battery was produced in the same way as in Example 1, except that the concentration of LiFSI in the electrolyte was changed to 0.05 mol/dm³. A composition and physical properties according to Example 2 are illustrated in Table 1.

### Example 3

In Example 3, a lithium sulfur battery was produced in the same way as in Example 1, except that the concentration of LiFSI in the electrolyte was changed to 0.1 mol/dm³. A composition and physical properties according to Example 3 are illustrated in Table 1.

### Example 4

In Example 4, a lithium sulfur battery was produced in the same way as in Example 1, except that the concentration of LiFSI in the electrolyte was changed to 0.15 mol/dm³. A composition and physical properties according to Example 4 are illustrated in Table 1.

### Example 5

In Example 5, a lithium sulfur battery was produced in the same way as in Example 4, except that LiTFSI was not included in the electrolyte. A composition and physical properties according to Example 5 are illustrated in Table 1.

### Example 6

In Example 6, a lithium sulfur battery was produced in the same way as in Example 4, except that the concentration of LiTFSI in the electrolyte was changed to 0.1 mol/dm³. A composition and physical properties according to Example 6 are illustrated in Table 1.

### Example 7

In Example 7, a lithium sulfur battery was produced in the same way as in Example 4, except that the concentration of LiTFSI in the electrolyte was changed to 0.5 mol/dm³. A composition and physical properties according to Example 7 are illustrated in Table 1.

### Example 8

In Example 8, a lithium sulfur battery was produced in the same way as in Example 4, except that the concentration of LiTFSI in the electrolyte was changed to 1.5 mol/dm³. A composition and physical properties according to Example 8 are illustrated in Table 1.

### Example 9

In Example 9, a lithium sulfur battery was produced in the same way as in Example 4, except that the concentration of LiTFSI was changed to 2.0 mol/dm³. A composition and physical properties according to Example 9 are illustrated in Table 1.

### Example 10

In Example 10, a lithium sulfur battery was produced in the same way as in Example 7, except that the concentration of the lithium polysulfide in the electrolyte was changed to 0.4 mol/dm³. A composition and physical properties according to Example 10 are illustrated in Table 1.

### Example 11

In Example 11, a lithium sulfur battery was produced in the same way as in Example 7, except that the concentration of the lithium polysulfide in the electrolyte was changed to 0.6 mol/dm³. A composition and physical properties according to Example 11 are illustrated in Table 1.

### Example 12

In Example 12, a lithium sulfur battery was produced in the same way as in Example 7, except that the concentration of the lithium polysulfide in the electrolyte was changed to 1.0 mol/dm³. A composition and physical properties according to Example 12 are illustrated in Table 1.

### Example 13

In Example 13, a lithium sulfur battery was produced in the same way as in Example 7, except that the concentration of the lithium polysulfide in the electrolyte was changed to 2.0 mol/dm³. A composition and physical properties according to Example 13 are illustrated in Table 1.

### Example 14

In Example 14, a lithium sulfur battery was produced in the same way as in Example 7, except that the lithium salt included in the electrolyte was changed to lithium nitrate (hereinafter, referred to as LiNO₃). A composition and physical properties according to Example 14 are illustrated in Table 1.

### Example 15

In Example 15, a lithium sulfur battery was produced in the same way as in Example 7, except that the lithium salt included in the electrolyte was changed to lithium trifluoromethanesulfonate (LiTFS). A composition and physical properties according to Example 15 are illustrated in Table 1.

### Example 16

In Example 16, a lithium sulfur battery was produced in the same way as in Example 7, except that the lithium polysulfide included in the electrolyte was changed to Li₂S₆. Note that, in Example 16, Li₂S₆ was synthesized and prepared by mixing sulfur and lithium sulfide at a molar ratio of 5:1.

### Example 17

In Example 17, a lithium sulfur battery was produced in the same way as in Example 7, except that the lithium polysulfide included in the electrolyte was changed to Li₂S₄. Note that, in Example 17, Li₂S₄ was synthesized and prepared by mixing sulfur and lithium sulfide at a molar ratio of 3:1. A composition and physical properties according to Example 17 are illustrated in Table 1.

### Example 18

In Example 18, a lithium sulfur battery was produced in the same way as in Example 7, except that the lithium polysulfide included in the electrolyte was changed to Li₂S₂. Note that, in Example 18, Li₂S₂ was synthesized and prepared by mixing sulfur and lithium sulfide at a molar ratio of 1:1. A composition and physical properties according to Example 18 are illustrated in Table 1.

### Example 19

In Example 19, a lithium sulfur battery was produced in the same way as in Example 4, except that lithium titanate and sulfurized polyacrylonitrile were not added (LTO/SPAN:none) and the composition of the sulfur positive electrode composite was S/porous-carbon-composite:AB:CNT:binder=92:1:2:5 (percent by weight). A composition and physical properties according to Example 19 are illustrated in Table 1.

### Example 20

In Example 20, a lithium sulfur battery was produced in the same way as in Example 4, except that the porous carbon in the S/porous carbon composite was changed to CNT. A composition and physical properties according to Example 20 are illustrated in Table 1.

### Example 21

In Example 21, a lithium sulfur battery was produced in the same way as in Example 7, except that the lithium salt included in the electrolyte was changed to lithium perchlorate (LiClO₄). A composition and physical properties according to Example 21 are illustrated in Table 1.

### Example 22

In Example 22, a lithium sulfur battery was produced in the same way as in Example 7, except that the lithium salt included in the electrolyte was changed to lithium hexafluorophosphate (LiPF₆). A composition and physical properties according to Example 22 are illustrated in Table 1.

### Example 23

In Example 23, a lithium sulfur battery was produced in the same way as in Example 7, except that the solvent included in the electrolyte was changed to sulfolane (SL). A composition and physical properties according to Example 23 are illustrated in Table 1.

### Example 24

In Example 24, a lithium sulfur battery was produced in the same way as in Example 7, except that the solvent included in the electrolyte was changed to tetraglyme (G4). A composition and physical properties according to Example 24 are illustrated in Table 1.

### Comparative Example 1

In Comparative Example 1, a lithium sulfur battery was produced in the same way as in Example 1, except that the concentration of the lithium polysulfide in the electrolyte was 0.3 mol/dm³ and LiFSI was not included in the electrolyte. A composition and physical properties according to Comparative Example 1 are illustrated in Table 1.

### Comparative Example 2

In Comparative Example 2, a lithium sulfur battery was produced in the same way as in Comparative Example 1, except that the lithium salt included in the electrolyte was changed to lithium trifluoromethanesulfonate (LiTFS). A composition and physical properties according to Comparative Example 2 are illustrated in Table 1.

### Comparative Example 3

In Comparative Example 3, a lithium sulfur battery was produced in the same way as in Example 1, except that the concentration of LiFSI in the electrolyte was changed to 0.2 mol/dm³. A composition and physical properties according to Comparative Example 3 are illustrated in Table 1.

### [Precipitation Form of Lithium Metal]

Using Example 4 or Comparative Example 1, discharging was performed at an atmosphere temperature of 60° C. and a current value of 1.1 mA (corresponding to 0.1 C) until 1.7 V was attained, and then charging was performed at the same current value until 2.6 V was attained. Subsequently, the lithium sulfur battery was disassembled, and the lithium metal serving as the negative electrode was taken out, washed with DME, and dried overnight at 100° C. in a vacuum. A surface of the sufficiently dried lithium metal was observed using a scanning electron microscope (SEM; JSM-6490A, manufactured by JEOL Ltd.) under an inert gas atmosphere.

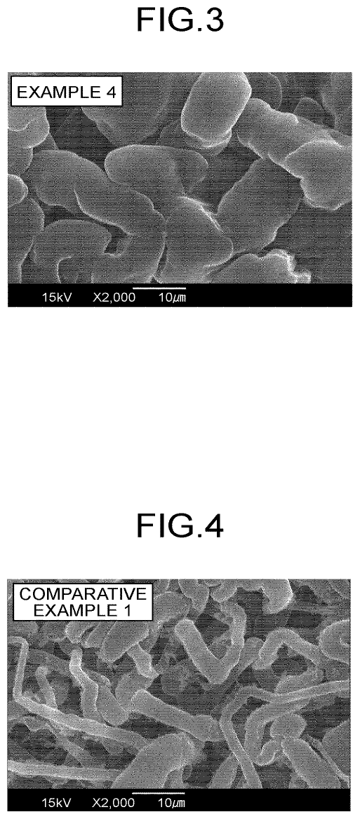

FIG. 2 to FIG. 4 are scanning electron microscope images of the surfaces of lithium metal taken out of the lithium sulfur batteries before charging and discharging, according to Example 4, and according to Comparative Example 1, respectively. As illustrated in FIG. 4, Comparative Example 1 takes a dendrite-like precipitation form, which leads to a high possibility of shortening the service life of the lithium metal negative electrode, reducing coulombic efficiency, and furthermore causing a short circuit. In contrast, Example 4 illustrated in FIG. 3 is roundish in shape and thereby can substantially suppress the problem described above. In addition, Example 4 is relatively larger in particle size. The larger particle size leads to a smaller specific surface area of the lithium metal and a smaller area of contact with the electrolyte. Consequently, it can be said that Example 4 is effective in substantially suppressing a side reaction of the electrolyte and further substantially suppressing degradation of the lithium sulfur battery.

### [Cycle Test of Lithium Sulfur Battery]

In Table 1, capacity retention rates in charge-and-discharge cycles of Examples and Comparative Examples are illustrated. Discharging was performed at an atmosphere temperature 60° C. and a current value of 1.1 mA until 1.7 V was attained, and then charging was performed at the same current density until 2.6 V was attained. Letting this charge-and-discharge be one cycle, 30 cycles of the charge-and-discharge were performed, and comparisons about initial discharge capacities, capacity retention rates, and coulombic efficiencies that are normalized by sulfur weight were made. The capacity retention rates and coulombic efficiencies were calculated using the following formulas. Note that the coulombic efficiencies are average coulombic efficiencies.

$$Capacity retention rate ( \% ) = Discharge capacities of cycles / Discharge capacity of the first cycle \times 100$$

$$Coulombic efficiency ( \% ) = Discharge capacities of ( n + 1 ) cycles / Charge capacity of {n}^{th} cycle \times 100$$

As illustrated in Table 1, when the electrolyte includes lithium polysulfide as the first component and lithium bis(fluorosulfonyl)imide as the second component and the concentration of lithium bis(fluorosulfonyl)imide is A, the lithium sulfur batteries satisfying 0.001 mol/dm³≤A≤0.15 mol/dm³ exhibited high battery performances.

Hereinafter, results obtained in the present examples will be discussed.

### 1. Effects of Concentration of Lithium Bis(fluorosulfonyl)imide

Comparisons among Examples 1 to 4 revealed that a higher concentration tended to lead to a higher coulombic efficiency. However, a concentration exceeding 0.15 mol/dm³ (Comparative Example 3) led to a decrease in capacity retention rate. Therefore, the concentration A of lithium bis(fluorosulfonyl)imide is preferably within a range of 0.01 mol/dm³≤A≤0.15 mol/dm³.

### 2. Effects of Third Component

### 2-1. Necessity of LiTFSI (Third Component)

A discharge capacity comparison between Example 5 and Example 6 revealed that Example 6, which included LiTFSI, was higher in capacity. The reason for this is probably that, since the electrolyte included LiTFSI, the lithium ion conductivity of the electrolyte was enhanced.

### 2-2. Concentration of LiTFSI (Third Component)

Comparisons among Example 4 and Examples 7 to 9 revealed that a higher concentration tended to lead to a smaller discharge capacity. This is attributed to an increase in viscosity (a decrease in lithium ion conductivity). Therefore, the concentration of the third component is preferably 1.5 mol/dm³ or lower, and more preferably 0.1 mol/dm³ or higher and 1.0 mol/dm³ or lower.

### 2-3. Effects of Type

Capacity retention rate comparisons among Examples 7, 14, 15, 21, and 22 revealed that Examples 7, 14, and 15 were higher in capacity retention rate, and hence it can be said that at least one of lithium nitrate, lithium bis(trifluoromethanesulfonyl)imide, and lithium trifluoromethanesulfonate is preferably included as the third component.

### 3. Effects of Concentration of Lithium Polysulfide

Discharge capacity comparisons among Examples 7 and 10 to 13 revealed that a higher concentration of lithium polysulfide tended to lead to a smaller discharge capacity.

Furthermore, a higher concentration of lithium polysulfide tended to lead to a higher coulombic efficiency. When the concentration B of lithium polysulfide satisfies preferably 0.001 mol/dm³≤B≤2.0 mol/dm³ and more preferably 0.2 mol/dm³≤B≤0.6 mol/dm³, the above-mentioned effects can be achieved. Note that, when the concentration B of lithium polysulfide exceeds 2.0 mol/dm³, there is a risk of an increase in the viscosity of the electrolyte (a decrease in ion conductivity) and a decrease in capacity.

### 4. Effects of Type of Lithium Polysulfide

Examples 7, 16, 17, and 18 exhibited the same performances. Hence, it follows that, as lithium polysulfide to be added in advance, not only Li₂Ss but also Li₂S₆, Li₂S₄, and Li₂S₂ can bring about the same effects.

### 5. Necessity for Positive Electrode Additives, Lithium Titanate and Sulfurized Polyacrylonitrile

As a result of a discharge capacity comparison between Example 4 and Example 19, Example 4, which included lithium titanate and sulfurized polyacrylonitrile, exhibited a higher discharge capacity, hence it can be said that lithium titanate and sulfurized polyacrylonitrile are preferably included in the positive electrode.

### 6. Necessity for Porous Carbon

As a result of discharge capacity comparison between Example 4 and Example 20, Example 4 in which porous carbon was used as a carbon material for the composite exhibited a higher discharge capacity, hence it can be said that porous carbon is preferably used.

### 7. Effects of Type of Solvent

As a result of discharge capacity comparisons among Examples 7, 23, and 24, Example 4 in which DOL and DME were used exhibited a higher discharge capacity, hence it can be said that DOL and DME are preferably used.

### 8. Necessity for Lithium Bis(fluorosulfonyl)imide

In Comparative Examples 1 and 2, which did not include lithium bis(fluorosulfonyl)imide, an early short circuit occurred. Hence it can be presumed that, when lithium bis(fluorosulfonyl)imide was not included, lithium metal dendrites were formed. Therefore, it can be said that lithium bis(fluorosulfonyl)imide needs to be included.

### INDUSTRIAL APPLICABILITY

As described above, the electrolyte for the lithium sulfur battery and the lithium sulfur battery according to the present invention are useful for achieving an electrolyte for lithium sulfur batteries and a lithium sulfur battery that have high cycle performance.

### REFERENCE SIGNS LIST

1 lithium sulfur battery
2 positive electrode
3 negative electrode
4 separator
21 positive electrode current collector
22 positive electrode composite layer
31 negative electrode current collector
32 negative electrode composite layer

1. An electrolyte, the electrolyte comprising:
a first component comprising lithium polysulfide;
a second component comprising lithium bis(fluorosulfonyl)imide; and
a solvent,
wherein a concentration A of the lithium bis(fluorosulfonyl)imide satisfies 0.001 mol/dm³≤A≤0.15 mol/dm³.

2. The electrolyte according to claim 1, wherein a concentration B of the lithium polysulfide satisfies 0.2 mol/dm³≤B≤2.0 mol/dm³.

3. The electrolyte according to claim 1, wherein the concentration A satisfies 0.05 mol/dm³≤A≤0.15 mol/dm³.

4. The electrolyte according to claim 2, wherein the concentration B satisfies 0.2 mol/dm³≤B≤0.6 mol/dm³.

5. The electrolyte according to claim 1, further comprising:
at least one lithium salt as a third component,
wherein a concentration of the lithium salt is from higher than 0 mol/dm³ to 1.5 mol/dm³ or lower.

6. The electrolyte according to claim 5, wherein the lithium salt includes at least one of lithium bis(trifluoromethanesulfonyl)imide, lithium nitrate, and lithium trifluoromethanesulfonate.

7. The electrolyte according to claim 1, wherein the solvent comprises 1,3-dioxolane and 1,2-dimethoxyethane.

8. A lithium sulfur battery, comprising:
a negative electrode including lithium metal or a lithium metal alloy;
a positive electrode comprising a positive electrode active material including sulfur or a sulfur compound as a major component; and
the electrolyte according to claim 1.

9. The lithium sulfur battery according to claim 8, wherein the positive electrode includes sulfurized polyacrylonitrile and lithium titanate.

10. The lithium sulfur battery according to claim 8, wherein the positive electrode further includes an electrically conductive additive.

11. The lithium sulfur battery according to claim 10, wherein the positive electrode further includes porous carbon.
